(19) United States
(12) Patent Application Publication
(10) Pub. No.: US 2006/0046079 A1
(43) Pub. Date: Mar. 2, 2006

(54) Method for preparing surfactant-templated, mesoporous low dielectric film

(75) Inventors: Jin Gyu Lee, Seoul (KR); Hyeon Jin Shin, Suwon-si (KR); Hyun Dam Jeong, Gyeonggi-Do (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Corning Co., Ltd., Gyeonggi-Do (KR)

(21) Appl. No.: 11/216,077

(22) Filed: Sep. 1, 2005

(30) Foreign Application Priority Data
Sep. 1, 2004 (KR) 2004-69524

(51) Int. Cl. B32B 5/18; B05D 3/02; C08L 83/04

(52) U.S. Cl. 428/447; 427/387; 524/863

(57) ABSTRACT

A method for preparing a surfactant-templated, mesoporous low dielectric film by mixing a siloxane-based polymer or oligomer, a surfactant and an organic solvent to prepare a coating solution, coating a substrate with the coating solution, and heat-curing the coated substrate. By the method, a thin film having a low dielectric constant and showing superior mechanical properties, such as hardness and modulus, can be prepared. Therefore, the low dielectric thin film can be applied to conductive materials, display materials, chemical sensors, biocatalysts, insulators, and packaging materials.

This non-provisional application claims priority under 35 U.S.C. § 119(a) on Korean Patent Application No. 2004-69524 filed on Sep. 1, 2004, which is herein incorporated by reference.

### BACKGROUND OF THE INVENTION

1. Field of the Invention

Embodiments of the present invention relate to a method for preparing a surfactant-templated, mesoporous low dielectric film, and more particularly to a method for preparing a mesoporous low dielectric film having superior physical properties by using a siloxane-based polymer or oligomer as a structure-directing agent.

2. Description of the Related Art

Recent developments in semiconductor fabrication techniques have increasingly led to small and highly integrated semiconductor devices. In the case of highly integrated semiconductor devices, the transmission of electric signals between metal wires may be delayed due to an increased mutual interference. For this reason, with the increasing integration of semiconductor devices, the speed between wirings has a significant impact on the performance of the semiconductor devices. Thus, an interlayer insulating film having a low charge capacity is required in order to lower the resistance and charge capacity between metal wires.

Silicon oxide films with a dielectric constant of around 4.0 have been used as interlayer insulating films for semiconductor devices. However, they face functional limitations as a result of the recent enhancement of the integration density. Under these circumstances, attempts have been made to lower the dielectric constant of insulating films. For instance, U.S. Pat. Nos. 3,615,272, 4,399,266, 4,756,977 and 4,999,397 disclose methods for preparing interlayer insulating films for semiconductor devices with a dielectric constant of about 2.5-3.1 by using polysilsesquioxanes.

In an attempt to lower the dielectric constant of an interlayer insulating film for a semiconductor device to 3.0 or lower, a porogen-templated approach is suggested wherein the siloxane-based resin is formulated with a pore-forming agent (i.e. porogen) and then the porogen is removed by pyrolysis. However, problems encountered with this approach are that pores collapse and connect with one another or are irregularly distributed during removal of the porogen. These problems deteriorate the mechanical properties of a porous dielectric film to be formed, and cause difficulties in chemically or mechanically applying the porous dielectric film to a dielectric film for semiconductor devices.

U.S. Pat. Nos. 5,057,296 and 5,102,643 describe mesoporous molecular sieve materials produced by using ionic surfactants as structure-directing agents. Since the mesoporous materials have a pore size in the mesoporous range (2-50 nm) and possess a very large surface area, they are superior in adsorptive capacity for atoms and molecules. In addition, since the mesoporous materials show a uniform pore size distribution, they can be applied to molecular sieves as well as they are expected to be very useful materials in a variety of industrial applications, such as interlayer dielectric films requiring a dielectric constant as low as 3.0, conductive materials, display materials, chemical sensors, fine chemistry and biocatalysis, insulators, and packaging materials.

U.S. Pat. No. 6,270,846 discloses a method for preparing a porous surfactant-templated thin film comprising the steps of mixing a precursor sol, a solvent, water, a surfactant and a hydrophobic polymer, coating a substrate with the mixture, evaporating a portion of the solvent to form a thin film, and heating the thin film.

U.S. Pat. No. 6,329,017 discloses a method for making a mesoporous thin film comprising the steps of mixing a silica precursor, an aqueous solvent, a catalyst and a surfactant to prepare a precursor solution, spin-coating said precursor solution into a templated film and removing the aqueous solvent.

U.S. Pat. No. 6,387,453 teaches a method for preparing a mesoporous material by mixing a precursor sol, a solvent, a surfactant and an interstitial compound to obtain a silica sol, and evaporating a portion of the solvent from the silica sol.

However, since the prior art methods for preparing surfactant-templated mesoporous thin films use a silane monomer, water and an acid, wetting occurs in the course of preparing the mesoporous thin films. This wetting generally involves problems that a desired low dielectric constant cannot be achieved, the thin film quality is deteriorated such that the dielectric constant cannot be measured, and the overall procedure is complicated, incurring considerable preparation costs.

### OBJECTS AND SUMMARY

Therefore, embodiments of the present invention have been made in view of the above problems of the methods of the cited, and a feature of embodiments of the present invention is to provide a method for preparing a surfactant-templated, mesoporous thin film having a sufficiently low dielectric constant (K) of 2.6 or less and superior mechanical properties (e.g., modulus and hardness) by using a coating solution wherein the thin film is ordered by a siloxane-based polymer or oligomer and the coating solution is prepared without the use of water so that no wetting occurs.

Another feature of embodiments of the present invention is to provide a method for preparing a surfactant-templated, mesoporous low dielectric thin film at reduced costs resulting from simplified preparation processes.

In order to accomplish the above features of embodiments of the present invention, there is provided a method for preparing a surfactant-templated, mesoporous low dielectric film, the method comprising the steps of: mixing a siloxane-based polymer or oligomer, a surfactant and an organic solvent to prepare a coating solution (a first step); and coating a substrate with the coating solution and heat-curing the coated substrate (a second step).

### BRIEF DESCRIPTION OF THE DRAWINGS

The above and other objects, features and other advantages of embodiments of the present invention will be more clearly understood from the following detailed description taken in conjunction with the accompanying drawings, in which:

FIG. 1 is an exemplary diagram illustrating the principle that a mesoporous thin film is prepared using a surfactant as a template in accordance with a method of embodiments of the present invention;

FIGS. 2a and 2b shows field emission scanning electron microscope (FESEM) images of a mesoporous low dielectric film prepared in Example 5;

FIGS. 3a and 3b are transmission electron microscope (TEM) images of a mesoporous low dielectric film prepared in Example 3;

FIGS. 4a and 4b are TEM images of the cross-section of a mesoporous low dielectric film prepared in Example 4;

FIG. 5 shows X-ray diffraction (XRD) patterns of a thin film (Comparative Example 1) prepared by applying a coating solution containing a siloxane-based polymer only, and that of a thin film (Example 5) prepared using a coating solution containing a siloxane-based polymer and a surfactant;

FIG. 6 shows XRD patterns of a thin film (Example 3) prepared using a coating solution containing a siloxane-based polymer and a surfactant (P123);

FIG. 7 shows XRD patterns of thin films (Examples 11, 12 and 13) prepared using coating solutions containing a siloxane-based polymer and a surfactant (CTAB) in different weight ratios; and

FIG. 8 shows XRD patterns of thin films (Comparative Example 4, and Examples 15, 16 and 17) prepared using coating solutions containing a siloxane-based polymer and a surfactant (Triton-X 100) in different weight ratios.

### DETAILED DESCRIPTION OF THE PREFERRED EMBODIMENTS

Embodiments of the present invention will now be described in more detail with reference to the accompanying drawings.

Embodiments of the present invention provide a method for preparing a surfactant-templated, mesoporous low dielectric thin film which comprises the steps of: mixing a siloxane-based polymer or oligomer, a surfactant and an organic solvent to prepare a coating solution; and coating a substrate with the coating solution and heat-curing the coated substrate. The mesoporous low dielectric film prepared by a method of embodiments of the present invention may be applied to low-dielectric constant interlayer insulating films, as well as have a wide range of applications, such as conductive materials, display materials, chemical sensors, biocatalysts, insulators, and packaging materials.

According to a method of embodiments of the present invention, the mesoporous low dielectric film is prepared by the following procedure. First, a siloxane-based polymer or oligomer, a surfactant, and an organic solvent are mixed to prepare a coating solution. At this step, the surfactant is preferred to have a concentration ranging from 10⁻³ mM to 500 mM.

As described above, the coating solution for the preparation of the mesoporous thin film may be prepared by simultaneously mixing a siloxane-based polymer or oligomer, an organic solvent, and a surfactant. Alternatively, the coating solution may be prepared by previously mixing a surfactant and a solvent, and then adding a siloxane-based polymer or oligomer thereto with stirring.

Thereafter, the coating solution is coated to a substrate, and then heat-cured to prepare the final mesoporous thin film.

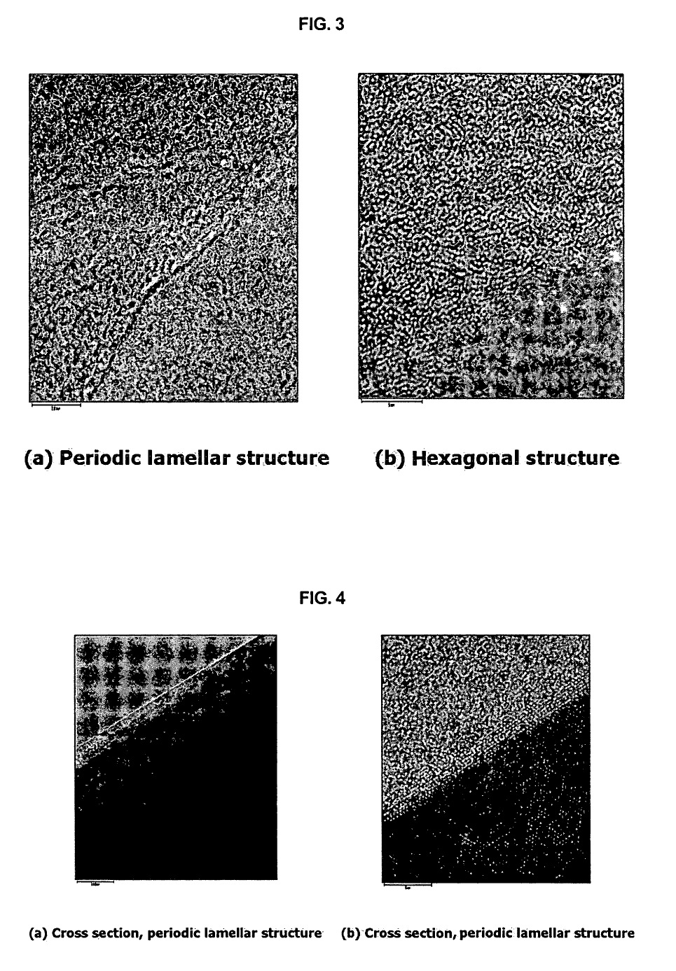

The subsequent evaporation of the solvent, carried out after the application of the coating solution to the substrate, induces micellization of the surfactant and allows continuous evaporation-induced self-assembly through calcination, thereby forming a hybrid mesophase between the polymer and the surfactant. This procedure enables the formation of a long- or short-range ordered film. The long-range ordered film shows high crystallinity due to its characteristics, as determined by the small-angle X-ray diffraction pattern. The thin film prepared by a method of embodiments of the present invention exhibits a monodisperse pore distribution regardless of whether it is long-range ordered or short-range ordered. The ordered film shows 2-dimensional periodicity, as demonstrated in TEM images shown in FIGS. 3 and 4. The short-range or long-range ordered film shows only single peak or multiple diffraction peaks at diffraction angles (2θ) of 0.3° to 10° on its X-ray diffraction pattern.

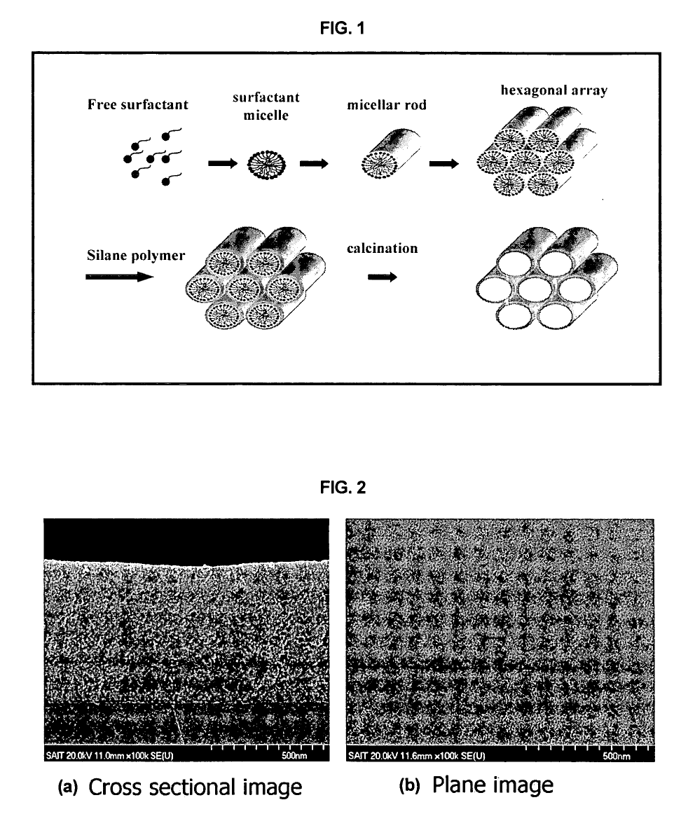

FIG. 1 exemplarily illustrates the principle that the mesoporous thin film is prepared using the surfactant as a template in accordance with a method of embodiments of the present invention. Referring to FIG. 1, the free surfactant forms a hexagonal array during evaporating a portion of the solvent. Thereafter, the siloxane-based polymer or oligomer is added to surround the surfactant. Subsequently, when the thin film is pyrolyzed by heating to 400° C. or more, the surfactant is removed and pores are formed, leading to an ordered porous film.

A non-limiting example of siloxane-based polymers and oligomers suitable for use in embodiments of the present invention is a polymer or oligomer prepared by hydrolyzing and homopolymerizing one monomer selected from the group consisting of a cyclic siloxane monomer represented by Formula 1, Si monomer having an organic bridge of Formula 2 and the linear alkoxy silane monomer of Formula 3 in an organic solvent in the presence of an acid or base catalyst and water, or a copolymer or oligomer prepared by hydrolyzing and polycondensing at least two monomers selected from the group consisting of monomers represented by Formula 1, Formula 2 and Formula 3 in an organic solvent in the presence of an acid or base catalyst and water: 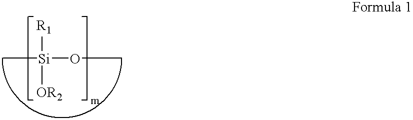
wherein R₁ is a hydrogen atom, a C₁₋₃ alkyl group, or a C₆₋₁₅ aryl group; R₂ is a hydrogen atom, a C₁₋₁₀ alkyl group, or SiX₁X₂X₃ (in which X₁, X₂, and X₃ are each independently a hydrogen atom, a C₁₋₃ alkyl group, a C₁₋₁₀ alkoxy group, or a halogen atom); and m is an integer of 3 to 8; 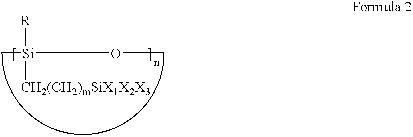
wherein R is a hydrogen atom, a C₁₋₃ alkyl group, a C₃₋₁₀ cycloalky group, or a C₆₋₅ aryl group; X₁, X₂, and X₃ are each independently a C₁₋₃ alkyl group, a C₁₋₁₀ alkoxy group, or a halogen group; n is an integer of 3 to 8; and m is an integer of 1 to 10; and
   Formula 3
   RSiX₁X₂X₃
wherein R is a hydrogen atom, a C₁₋₃ alkyl group, a fluorinated alkyl group, an aryl group, a C₃₋₁₀ a cycloalkyl group, or a C₆₋₁₅ aryl group; and X₁, X₂, and X₃ are each independently a C₁₋₃ alkyl group, a C₁₋₁₀ alkoxy group, or a halogen group.

The siloxane-based polymer or oligomer used in embodiments of the present invention preferably has a weight-average molecular weight of 500-100,000.

A preferred cyclic siloxane compound of Formula 1 is one wherein R₁ is methyl, R₂ is Si(OCH₃)₃ and m is 4, that is, the compound (TS-T4Q4) represented by Formula 4 below:

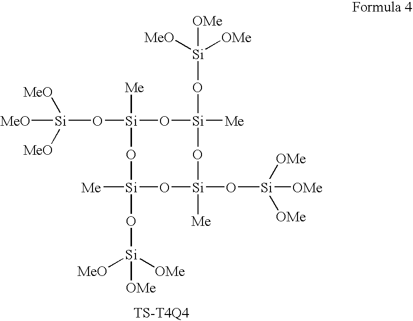

A preferred Si monomer having an organic bridge of Formula 2 is the compound (TCS-2) represented by Formula 5 below:

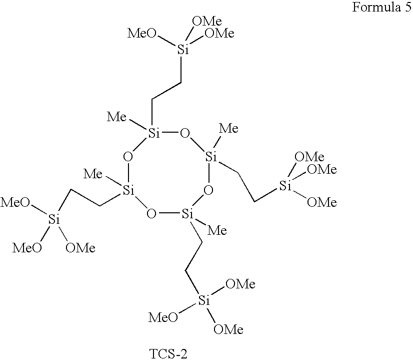

The silane-based monomer usable for a preparation of the siloxane-based polymer in embodiments of the present invention contains at least one hydrolysable reactive group bonded to a silicon atom, as represented by Formula 3. Specific examples of the linear alkoxy silane monomer of Formula 3 include methyltriethoxysilane, methyltrimethoxysilane, methyltri-n-propoxysilane, phenyltrimethoxysilane, phenyltriethoxysilane, phenyltrichlorosilane, phenyltrifluorosilane, phenethyltrimethoxysilane, methyltrichlorosilane, methyltribromosilane, methyltrifluorosilane, triethoxysilane, trimethoxysilane, trichlorosilane, trifluorosilane, 3,3,3-trifluoropropyl trimethoxysilane, cyanoethyltrimethoxysilane, and the like.

A suitable siloxane-based polymer or oligomer for use in embodiments of the present invention may also be a silsesquioxane-based polymer prepared by homopolymerizing the linear alkoxy silane monomer of Formula 3, or copolymerizing at least two monomers selected from the group consisting of alkoxy silane monomers that can be represented by Formula 3.

The surfactant acting as a porogen in a method of embodiments of the present invention may be selected from anionic surfactants, cationic surfactants, and non-ionic surfactants or block copolymers. Examples of anionic surfactants include, but are not limited to, sulfates, sulfonates, phosphates, and carboxylic acids. Examples of cationic surfactants include, but are not limited to, alkylammonium salts, gemini surfactants, cetyltrimethylpiperidinium salts, and dialkyldimethylammonium salts. Examples of non-ionic surfactants include, but are not limited to, primary amines, poly(oxyethylene) oxides, octaethylene glycol monodecyl ether, octaethylene glycol monohexadecyl ether, and block copolymers. Of these, preferred surfactants are cetyltrimethylammonium bromide (CTAB), octylphenoxypolyethoxy(9-10) ethanol (Triton X-100), poly(oxyethylene-co-oxypropylene) block copolymer (Formula HO(CH₂CH₂O)₂₀(CH₂CHCH₃O)₇₀(CH₂CH₂O)₂₀H, hereinafter referred to as “P123”), and ethylenediamine alkoxylate block copolymers.

Examples of suitable organic solvents for use in embodiments of the present invention include alcohol-, ketone-, ether-, acetate-, amide- and silicon-based solvents, and mixtures thereof. As preferred organic solvents, there may be used, for example: ketone-based solvents, such as methyl isobutyl ketone, 1-methyl-2-pyrrolidinone, cyclohexanone and acetone; ether-based solvents, such as tetrahydrofuran and isopropyl ether; acetate-based solvents, such as ethyl acetate, butyl acetate and propylene glycol methyl ether acetate; alcohol-based solvents, such as ethyl alcohol, methyl alcohol, propanol, isopropyl alcohol and butyl alcohol; amide-based solvents, such as dimethylacetamide and dimethylformamide; silicon-based solvents; and mixtures thereof.

In embodiments of the present invention, the application of the coating solution may be carried out by, but is not especially limited to, spin coating, dip coating, spray coating, flow coating and screen printing techniques. The more preferred coating techniques are spin coating and dip coating.

The heat curing is carried out by preheating the coated substrate at 60-170° C. for 5 minutes to 24 hours, followed by heating at 350-450° C. for 10 minutes to 24 hours.

The mesoporous low dielectric film prepared by a method of embodiments of the present invention preferably has a dielectric constant of 2.6 or less, and has a hexagonal, cubic or lamellar structure. In addition, the mesoporous low dielectric film shows X-ray diffraction peaks at diffraction angles (2θ) of 0.3° to 10°.

Preferred embodiments of the present invention will now be described in detail with reference to the following examples. However, these examples are given for the purpose of illustration and are not to be construed as limiting the scope of the invention.

Preparation of Siloxane-Based Polymer A

8.24 mmol of the monomer (TS-T4Q4) of Formula 4 below and 3.53 mmol of methyltrimethoxysilane (MTMS, Aldrich) as an alkoxy silane monomer were placed into a flask, and then tetrahydrofuran was added to the flask to dilute the monomer mixture until the concentration reached 0.5-0.7M. The reaction solution was cooled to −78□6C. After 0.424 mmol of hydrochloric acid and 141.2 mmol of water were added to the flask, the reaction temperature was gradually raised to 70° C. At this temperature, the reaction was continued for 16 hours. The reaction solution was transferred to a separatory funnel, followed by the addition of diethyl ether and tetrahydrofuran in the same amounts as the first amount of tetrahydrofuran. The resulting mixture was washed three times with water in the amount of one tenth of the total volume of the solvents used, and was then distilled at reduced pressure to remove volatile materials, giving a polymer as a white powder. The polymer was dissolved in tetrahydrofuran until it became transparent, and passed through a filter (pore size: 0.2 μm). Water was added to the filtrate to obtain a precipitate as a white powder. The precipitate was dried under 0.1 torr at 0-20° C. for 10 hours to afford a siloxane-based polymer (“A”). The amounts of the monomers, HCl and water used to prepare the polymer are shown in Table 1 below. The amounts of the polymer, and the contents of Si—OH, Si—OCH₃ and S₁—CH₃ in the polymer are shown in Table 1 below. The Si—OH, Si—OCH₃ and S₁—CH₃ contents were determined by nuclear magnetic resonance (NMR, Bruker) spectroscopy.

TABLE 1

| | |
|---|---|
| | (4) |
| 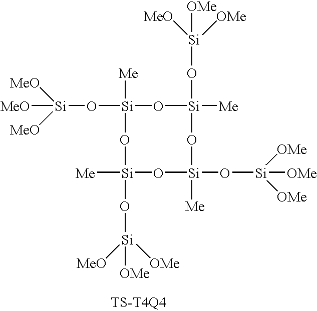 | |

| | | | | | Amount of | | Si— | |
|---|---|---|---|---|---|---|---|---|
| | TS-T4Q4 | MTMS | HCl | H₂O | polymer A | Si—OH | OCH₃ | Si—CH₃ |
| Polymer | (mmol) | (mmol) | (mmol) | (mmol) | (g) | (%) | (%) | (%) |
| Polymer A | 5.09 | 20.36 | 1.222 | 407.2 | 3.70 | 33.60 | 1.30 | 65.10 |

Preparation of Siloxane-Based Polymer B

The cyclic siloxane-based monomer (TCS-2) of Formula 5 and methyltrimethoxysilane were diluted in 100 ml of tetrahydrofuran, and then the dilution was introduced into a flask. The internal temperature of the flask was cooled to −78° C. A certain amount of hydrochloric acid (HCl) was diluted in a certain amount of deionized water at −78° C., and then water was slowly added thereto. The solution was slowly heated to 70° C., and was then reacted at 60° C. for 16 hours. The reaction solution was transferred to a separatory funnel, followed by the addition of diethyl ether (150 ml), washing with water (30 ml×3) and removal of volatile materials under reduced pressure, to give a polymer as a white powder. The polymer was dissolved in a small amount of acetone, and passed through a filter (pore size: 0.2 μm) to remove fine powder particles and other impurities. Water was slowly added to the obtained supernatant to obtain a precipitate as a white powder. The obtained white powder was separated from the solution fraction (mixture of the acetone and water), and dried under a reduced pressure of 0.1 torr at 0-5° C. to fractionate a siloxane-based polymer (“B”). The amounts of the monomers, acid catalyst, water, and siloxane-based polymer B are shown in Table 2 below.

TABLE 2

| | Monomers (mmol) | | | | |
|---|---|---|---|---|---|
| | Monomer | | HCl | H₂O | Amount of |
| Polymer | TCS-2 | MTMS | (mmol) | (mmol) | polymer B (g) |
| Polymer B | 3.895 | 35.045 | 0.015 | 506.289 | 4.21 |

### Examples 1-31 and Comparative Examples 1-7

First, 0.05 g of P123 as a surfactant was dissolved in 4 g of anhydrous ethanol, and then 0.45 g of the siloxane-based polymer A was added thereto until the total concentration reached 11.1 wt % to prepare a coating solution for the preparation of a mesoporous dielectric thin film (Example 1).

Coating solutions were prepared in the same manner as in Example 1, except that the kind and amount of the surfactant and siloxane-based polymer used were changed as indicated in Tables 3-6 below (Examples 2-31 and Comparative Examples 1-7).

Each of these coating solutions thus prepared was spin-coated on a silicon wafer at 3,000 rpm for 30 seconds, and pre-baked on a hot plate under nitrogen atmosphere at 150° C. for 1.5 hours. The pre-baked silicon wafer was dried to form a film. While heating at 3° C./min. to 420° C. for 1 hour, the dried film was baked under vacuum to form an insulating film. The thickness, dielectric constant, hardness, and modulus of the respective insulating films were measured. The results are shown in Tables 3-6.

Methods for Measurement of Physical Properties

First, the procedures for measuring the physical properties of the insulating films prepared in Examples 1-31 and Comparative Examples 1-7 are explained in detail.

1) Measurement of Dielectric Constant

A silicon thermal oxide film was applied to a boron-doped p-type silicon wafer to a thickness of 3,000 Å, and then a 100 Å thick titanium film, a 2,000 Å thick aluminum film and a 100 Å thick titanium film were sequentially formed on the silicon oxide film using a metal evaporator. Thereafter, a insulating film was coated on the resulting structure, after which a 100 Å thick spherical titanium thin film (diameter: 1 mm) and a 5,000 Å thick aluminum thin film (diameter: 1 mm) were sequentially formed on the insulating film using a hardmask designed so as to have an electrode diameter of 1 mm, to form a metal-insulator-metal (MIM)-structured low dielectric film for dielectric constant measurement. The capacitance of the thin film was measured at around 10 kHz, 100 kHz and 1 MHz using a PRECISION LCR METER (HP4284A) accompanied with a probe station (Micromanipulator 6200 probe station). The thickness of the thin film was measured using a prism coupler. The dielectric constant of the thin film was calculated according to the following equation:
κ=C×d/∈ₒ×A
in which K is the relative permittivity, C is the capacitance of the insulating film, ∈ₒ is the dielectric constant of a vacuum (8.8542×10⁻¹² Fm⁻¹), d is the thickness of the insulating film, and A is the contact cross-sectional area of the electrode.
2) Hardness and Elastic Modulus

The hardness and modulus of a thin film were determined by quantitative analysis using a Nanoindenter II (MTS). Specifically, when the thin film was indented into the Nanoindenter until the indentation depth reached 10% of the overall thickness of the thin film, the hardness and modulus of the thin film were measured. At this time, the thickness of the thin film was measured using a prism coupler. In order to ensure better reliability of these measurements in the Examples 1-31 and Comparative Examples 1-7, the hardness and modulus were measured at a total of 6 indentation points on the insulating film, and the obtained values were averaged.

3) Analysis of Pore Structure

The structures of the surfactant-templated mesoporous thin films prepared in Examples 1-31 were analyzed by small-angle X-ray diffraction and transmission electron microscopy. The results are shown in FIGS. 2 through 8. The X-ray diffraction spectra were obtained by scanning an area of 1 cm² (1 cm×1 cm) under the following experimental conditions:
X-ray power: 40 kV, 30 mA
Scan mode: θ/2θ scan
Scan range: 0.1-10 deg(2θ)
Scan rate=0.30 deg/min
R/S: 1/16 deg

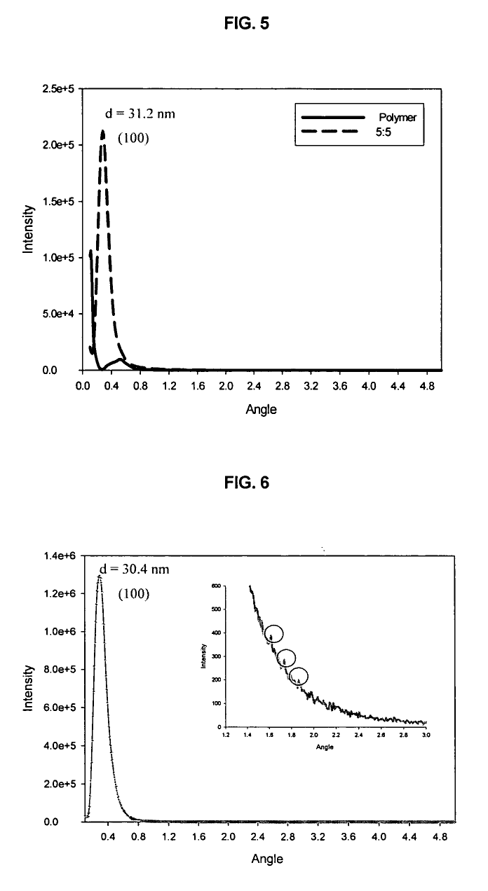

Further, d-spacing values shown in FIGS. 5 to 8 were calculated from the equation nλ=2d sin θ.

TABLE 3

| | | Weight | | Dielectric | | |
|---|---|---|---|---|---|---|
| Example | | ratio | Thickness | constant (K), | Modulus | Hardness |
| No. | Polymer:surfactant | polymer:surfactant | (nm) | 1 MHz | (GPa) | (GPa) |
| Comp. Ex. 1 | A/P123* | 10:0 | 662 | 2.9 | 10.06 | 1.74 |
| Example 1 | A/P123 | 9:1 | 624 | 2.53 | 7.89 | 1.33 |
| Example 2 | A/P123 | 8:2 | 584 | 2.35 | 6.10 | 1.04 |
| Example 3 | A/P123 | 7:3 | 557 | 2.02 | 4.44 | 0.72 |
| Example 4 | A/P123 | 6:4 | 552 | 1.99 | 3.45 | 0.55 |
| Example 5 | A/P123 | 5:5 | 510 | 1.87 | 2.86 | 0.43 |
| Comp. Ex. 2 | A/P103* | 10:0 | 490 | 2.81 | 10.06 | 1.74 |
| Example 6 | A/P103 | 9:1 | 563 | 2.52 | 7.22 | 1.20 |
| Example 7 | A/P103 | 8:2 | 550 | 2.32 | 5.35 | 0.86 |
| Example 8 | A/P103 | 7:3 | 472 | 2.02 | 4.86 | 0.76 |
| Example 9 | A/P103 | 6:4 | 522 | 1.03 | 3.72 | 0.56 |
| Example 10 | A/P103 | 5:5 | 506 | 1.98 | 2.15 | 0.30 |

*P123: triblock copolymer of polyethylene oxide (PEO)-polypropylene oxide (PPO)-polyethylene oxide (PEO), weight-average molecular weight: 5750
*P103: triblock copolymer of polyethylene oxide (PEO)-polypropylene oxide (PPO)-polyethyleneoxide (PEO), weight-average molecular weight: 4950

TABLE 4

| | | Weight | | Dielectric | | |
|---|---|---|---|---|---|---|
| Example | | ratio | Thickness | constant | Modulus | Hardness |
| No. | Polymer:surfactant | polymer:surfactant | (nm) | (K), 1 MHz | (GPa) | (GPa) |
| Comp. Ex. 3 | A/CTAB | 10:0 | 594 | 2.9 | 9.18 | 1.38 |
| Example 11 | A/CTAB | 9:1 | 535 | 2.6 | 8.02 | 1.29 |
| Example 12 | A/CTAB | 8:2 | 539 | 2.33 | 5.50 | 0.89 |
| Example 13 | A/CTAB | 7:3 | 527 | 2.04 | 4.01 | 0.65 |
| Example 14 | A/CTAB | 5:5 | 461 | 1.64 | 1.99 | 0.32 |
| Comp. Ex. 4 | A/Tx100 | 10:0 | 594 | 2.9 | 9.18 | 1.38 |
| Example 15 | A/Tx100 | 9:1 | 506 | 2.36 | 8.73 | 1.41 |
| Example 16 | A/Tx100 | 8:2 | 508 | 2.32 | 6.17 | 0.98 |
| Example 17 | A/Tx100 | 7:3 | 453 | 2.14 | 4.90 | 0.74 |
| Example 18 | A/Tx100 | 5:5 | 399 | 1.92 | 2.32 | 0.36 |

TABLE 5

| | | Weight | | Dielectric | | |
|---|---|---|---|---|---|---|
| | | ratio | Thickness | constant | Modulus | Hardness |
| Example No. | Polymer:surfactant | polymer:surfactant | (nm) | (K), 1 MHz | (GPa) | (GPa) |
| Comp. Ex. 5 | B/CTAB | 10:0 | 1826 | 2.88 | 5.44 | 0.99 |
| Example 19 | B/CTAB | 9:1 | 1498 | 2.43 | 4.79 | 0.88 |
| Example 20 | B/CTAB | 7:3 | 1202 | 2.18 | 2.93 | 0.52 |
| Example 21 | B/Tx100* | 9:1 | 1346 | 2.33 | 5.19 | 0.97 |
| Example 22 | B/Tx100 | 7:3 | 1188 | 2.30 | 5.23 | 0.95 |
| Example 23 | B/Tx100 | 5:5 | 1016 | 2.05 | 1.88 | 0.30 |

*Tx100: Triton X-100, 4-octylphenol ethoxylate represented by C₁₄H₂₂O(C₂H₄O)ₙ (where n is a number between 3 and 40).

TABLE 6

| | | | | Dielectric | | |
|---|---|---|---|---|---|---|
| Example | | Weight ratio | Thickness | constant | Modulus | Hardness |
| No. | Polymer:surfactant | polymer:surfactant | (nm) | (K), 1 MHz | (GPa) | (GPa) |
| Comp. Ex. 6 | B/P123 | 10:0 | 1826 | 2.88 | 5.44 | 0.99 |
| Example 24 | B/P123 | 9:1 | 884 | 2.34 | 3.76 | 0.65 |
| Example 25 | B/P123 | 7:3 | 922 | 2.24 | 3.38 | 0.63 |
| Example 26 | B/P123 | 6:4 | 854 | 2.05 | — | — |
| Example 27 | B/P123 | 5:5 | 779 | 1.84 | 2.67 | 0.44 |
| Comp. Ex. 7 | B/P103 | 10:0 | 1043 | 2.60 | 5.44 | 0.99 |
| Example 28 | B/P103 | 9:1 | 1013 | 2.32 | 4.91 | 0.86 |
| Example 29 | B/P103 | 7:3 | 992 | 2.37 | 4.48 | 0.76 |
| Example 30 | B/P103 | 6:4 | 777 | 2.09 | 3.73 | 0.64 |
| Example 31 | B/P103 | 5:5 | 704 | 2.15 | 2.83 | 0.45 |

FIGS. 2a and 2b show field emission scanning electron microscope (FESEM) images of the thin film (Example 5) prepared using the coating solution containing the siloxane-based polymer A and the surfactant (P123) in a weight ratio of 1:1. The cross-sectional image (FIG. 2a) and plane image (FIG. 2b) indicate that the thin film was very uniformly ordered with no cracks.

FIGS. 3a and 3b show transmission electron microscope (TEM) images of the thin film (Example 3) prepared using the coating solution containing the siloxane-based polymer A and the surfactant (P123). Specifically, FIGS. 3a and 3b are plane images of the thin film (Example 3) prepared by applying the coating solution containing the siloxane-based polymer A and the surfactant (P123) in a weight ratio of 7:3 to a silicon thin film, and curing the coated silicon thin film. As is apparent from FIG. 3a, the thin film formed on the silicon thin film had a periodic lamellar pattern. A magnification of the surface (FIG. 3b) shows that spheres having a size of about 2.5 nm were hexagonally stacked. Since such periodically dispersed pores can equally distribute an externally applied stress over all parts of the thin film, the thin film will show improved mechanical properties, such as modulus and hardness, when compared to a thin film having randomly dispersed pores. This fact is supported by the data shown in Tables 3 to 6.

FIGS. 4a and 4b show transmission electron microscope (TEM) images of the thin film (Example 4) prepared using the coating solution containing the siloxane-based polymer A and the surfactant (P123) in a weight ratio of 6:4. As can be seen from FIGS. 4a and 4b, the thin film had a periodic lamellar pattern.

FIG. 5 shows X-ray diffraction (XRD) patterns of the thin film (Comparative Example 1) prepared by applying the coating solution containing the siloxane-based polymer A only, and that of the thin film (Example 5) prepared using the coating solution containing the siloxane-based polymer A and the surfactant (P123) in a weight ratio of 5:5. The X-ray diffraction analysis indicates that the thin film prepared in Comparative Example 1 showed a broad X-ray diffraction peak, whereas the thin film prepared in Example 5 showed a very strong X-ray diffraction peak. These results confirm that the thin film of Example 5 had a periodic lamellar pattern.

FIG. 6 shows XRD patterns of the thin film (Example 3) prepared using the coating solution containing the siloxane-based polymer A and the surfactant (P123) in a weight ratio of 7:3. The thin film showed a strong X-ray diffraction peak at a diffraction angle (2θ) of 0.4°. From the internal graph shown in FIG. 6, weak diffraction peaks were observed at diffraction angles (2θ) of 1.62°, 1.75° and 1.9°.

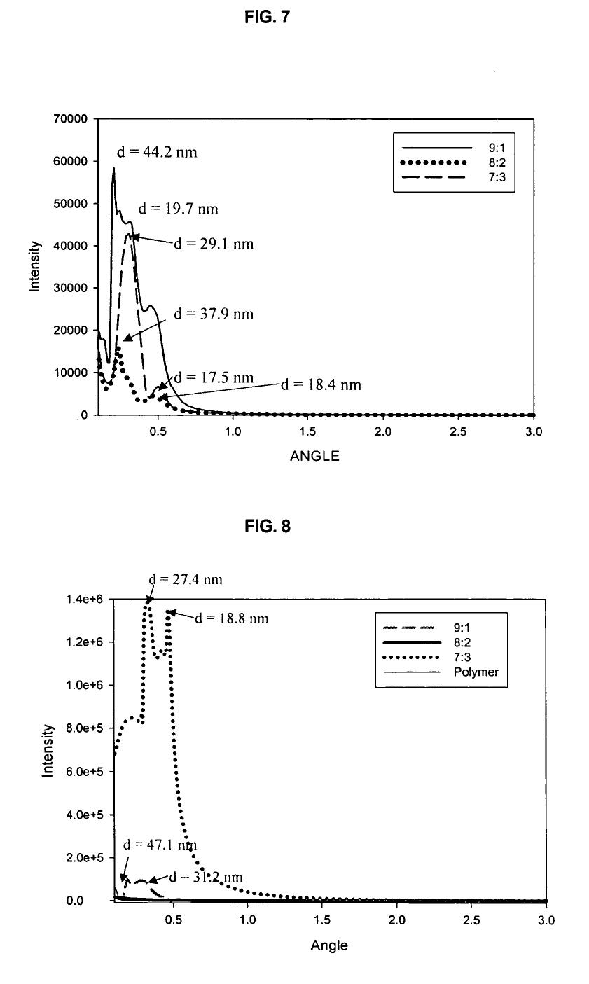

FIG. 7 shows XRD patterns of the thin films (Examples 11, 12 and 13) prepared using the coating solutions containing the siloxane-based polymer A and the surfactant (CTAB) in weight ratios of 9:1, 8:2, and 7:3, respectively. The thin films were observed to show multiple diffraction peaks at diffraction angles (2θ) of 0.3° to 10°. It could be confirmed from FIG. 7 that as the concentration of the surfactant increased, ordering was shown at a narrow spacing. This is because the spacing between ordered lamellars is narrow (or packing density is high) and hence d-spacing is small.

FIG. 8 shows XRD patterns of the thin films (Comparative Example 4, and Examples 15 and 16) prepared using the coating solutions containing the siloxane-based polymer A and the surfactant (Triton-X 100) in weight ratios of 10:0, 9:1, and 8:2, respectively. These thin films showed multiple diffraction peaks at diffraction angles (2θ) of 0.3° to 10°.

### Comparative Example 8

A 25 mM aqueous cetyltrimethylammonium bromide (CTAB) solution and a 25 mM aqueous sodium salicylate solution were mixed, and aged at room temperature for at least 3 days. At this time, the cetyltrimethylammonium bromide (CTAB) was used as a surfactant. Thereafter, a precursor, 1 M tetraethylorthosilicate (TEOS), and 0.1 M hydrochloric acid (35%) were added to the aged solution to prepare a coating solution. The coating solution was spin-coated several times on a silicon wafer at 3,000 rpm for 30 seconds, and pre-baked on a hot plate under nitrogen atmosphere at 200° C. for 30 minutes. The pre-baked silicon wafer was dried to form a film. While heating at 3° C./min. to 450° C. for 2 hours, the dried film was baked under vacuum to form an insulating film. The thickness, dielectric constant, and quality of the insulating film were measured. The results are shown in Table 7 below.

### Comparative Example 9

Cetyltrimethylammonium bromide (CTAB) as a surfactant solution was dissolved in a mixed solution of ethano/water (22/5) to prepare a 25 mM solution, and aged at room temperature for one day. Thereafter, a precursor, 1 M tetraethylorthosilicate (TEOS), and 0.5 M TCS-2 were added to the aged solution to prepare a coating solution. The coating solution was spin-coated several times on a silicon wafer at 3,000 rpm for 30 seconds, and pre-baked on a hot plate under nitrogen atmosphere at 200° C. for 30 minutes. The pre-baked silicon wafer was dried to form a film. While heating at 3° C./min. to 450° C. for 2 hours, the dried film was baked under vacuum to form an insulating film. The thickness, dielectric constant, and quality of the insulating film were measured. The results are shown in Table 7 below.

### Comparative Example 10

Cetyltrimethylammonium bromide (CTAB) as a surfactant solution was dissolved in a mixed solution of ethanol/water (22/5) to prepare a 25 mM solution, and aged at room temperature for one day. Thereafter, a precursor, 1 M tetraethylorthosilicate (TEOS), 50 mM TCS-2, and 0.1 M HCl (35%) were added to the aged solution to prepare a coating solution. The coating solution was spin-coated several times on a silicon wafer at 3,000 rpm for 30 seconds, and pre-baked on a hot plate under nitrogen atmosphere at 150° C. for 30 minutes. The pre-baked silicon wafer was dried to form a film. While heating at 3° C./min. to 450° C. for 2 hours, the dried film was baked under vacuum to form an insulating film. The thickness, dielectric constant, and quality of the insulating film were measured. The results are shown in Table 7 below.

TABLE 7

| | | | | Dielectric | |
|---|---|---|---|---|---|
| | Precursor/ | Weight ratio | Thickness | constant | Quality of |
| Example No. | surfactant | precursor:surfactant | (mm) | (K), 1 MHz | thin film |
| Comp. Ex. 8 | TEOS/CTAB | 40:1 | 7000 | 4.9 | Cracks |
| | | | | | observed |
| Comp. Ex. 9 | TEOS + TCS- | 60:1 | 4000 | Not | Cracks |
| | 2/CTAB | | | measurable | observed |
| Comp. Ex. 10 | TEOS + TCS- | 42:1 | 1130 | 4.1 | Opaque |
| | 2/CTAB | | | | |

During preparation of the thin films (Comparative Examples 8-10) using a silane monomer, water and an acid, wetting occurred. As can be seen from the data shown in Table 7, the thin films could not achieve a low dielectric constant of 2.6 or less, and the quality was so deteriorated that the dielectric constant could not be measured.

As apparent from the above description, since methods of embodiments of the present invention do not require the use of water during preparation of a coating solution, wetting does not occur, leading to a mesoporous low dielectric film having a dielectric constant of 2.6 or less. In addition, according to methods of embodiments of the present invention, the preparation processes are simplified and thus systematic fine processing is possible at low costs. Furthermore, a mesoporous thin film prepared by a method of an embodiment of the present invention has advantages in terms of a low dielectric constant and superior mechanical properties, such as modulus and strength.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for preparing a surfactant-templated, mesoporous low dielectric film, comprising the steps of:
(a) mixing a siloxane-based polymer or oligomer, a surfactant and an organic solvent to prepare a coating solution; and
(b) coating a substrate with the coating solution and heat-curing the coated substrate.

2. The method according to claim 1, wherein the surfactant has a concentration ranging from 10⁻³ mM to 500 mM in step (a).

3. The method according to claim 1, wherein step (a) comprises the sub-steps of:
mixing a surfactant and a solvent; and
adding a siloxane-based polymer or oligomer to the mixture to prepare a coating solution.

4. The method according to claim 1, wherein the siloxane-based polymer or oligomer is a polymer or oligomer prepared by hydrolyzing and homopolymerizing one monomer selected from the group consisting of a cyclic siloxane monomer represented by Formula 1, Si monomer having an organic bridge of Formula 2 and the linear alkoxy silane monomer of Formula 3 in an organic solvent in the presence of an acid or base catalyst and water, or a copolymer or oligomer prepared by hydrolyzing and polycondensing at least two monomers selected from the group consisting of monomers represented by Formula 1, Formula 2 and Formula 3 in an organic solvent in the presence of an acid or base catalyst and water: 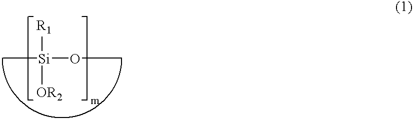
wherein R₁ is a hydrogen atom, a C₁₋₃ alkyl group, or a C₆₋₁₅ aryl group; R₂ is a hydrogen atom, a C₁₋₁₀ alkyl group, or SiX₁X₂X₃ (in which X₁, X₂, and X₃ are each independently a hydrogen atom, a C₁₋₃ alkyl group, a C₁₋₁₀ alkoxy group, or a halogen atom); and m is an integer of 3 to 8; 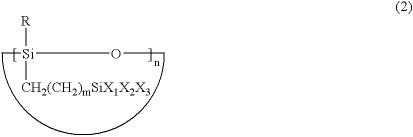
wherein R₁ is a hydrogen atom, a C₁₋₃ alkyl group, a C₃₋₁₀cycloalky group, or a C₆₋₁₅ aryl group; X₁, X₂, and X₃ are each independently a C₁₋₃ alkyl group, a C₁₋₁₀ alkoxy group, or a halogen group; n is an integer of 3 to 8; and m is an integer of 1 to 10;
RSiX₁X₂X₃ (3)
wherein R is a hydrogen atom, a C₁₋₃ alkyl group, a fluorinated alkyl group, an aryl group, a C₃₋₁₀ a cycloalkyl group, or a C₁₋₅ aryl group; and X₁, X₂, and X₃ are each independently a C₁₋₃ alkyl group, a C₁₋₁₀ alkoxy group, or a halogen group.

5. The method according to claim 1, wherein the siloxane-based polymer or oligomer has a weight-average molecular weight of 500-100,000.

6. The method according to claim 1, wherein the siloxane-based polymer or oligomer is a silsesquioxane polymer or oligomer.

7. The method according to claim 1, wherein the surfactant is selected from the group consisting of sulfates, sulfonates, phosphates, carboxylic acids, alkylammonium salts, gemini surfactants, cetyltrimethylpiperidinium salts, dialkyldimethylammonium salts, primary amines, poly(oxyethylene) oxides, octaethylene glycol monodecyl ether, octaethylene glycol monohexadecyl ether, and block copolymers.

8. The method according to claim 7, wherein the surfactant is selected from the group consisting of cetyltrimethylammonium bromide, octylphenoxypolyethoxy(9-10) ethanol, poly(oxyethylene-co-oxypropylene) block copolymer, and ethylenediamine alkoxylate block copolymers.

9. The method according to claim 1, wherein the organic solvent is selected from the group consisting of ketone-, ether-, acetate-, alcohol-, amide- and silicon-based solvents, and mixtures thereof.

10. The method according to claim 1, wherein the application of the coating solution is carried out by spin coating, dip coating, spray coating, flow coating, or screen printing.

11. The method according to claim 1, wherein the heat curing is carried out by preheating the coated substrate at 60-170° C. for 5 minutes to 24 hours, followed by heating at 350-450° C. for 10 minutes to 24 hours.

12. The method according to claim 1, wherein the thin film has a dielectric constant of 2.6 or less, and has a hexagonal, cubic or lamellar structure.

13. The method according to claim 1, wherein the thin film shows X-ray diffraction peaks at diffraction angles (2θ) of 0.30 to 10°.

14. An interlayer insulating film for a semiconductor device prepared by the method according to claim 1.
